(19) United States
(12) Patent Application Publication
(10) Pub. No.: US 2010/0326893 A1
(43) Pub. Date: Dec. 30, 2010

(54) METHOD AND APPARATUS FOR REPOSITIONING INDIVIDUALLY PACKAGED PRODUCTS

(76) Inventors: Emil Hueppi, Uhwiesen (CH); Roland Czuday, Winterthur (CH)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/521,466

(22) PCT Filed: Dec. 7, 2007
(86) PCT No.: PCT/EP07/63486

§ 371 Date: Sep. 15, 2010

(30) Foreign Application Priority Data
Dec. 27, 2006 (DE) 102006061571.9

(51) Int. Cl. B07C 5/38; B07C 5/16; B65B 35/36; B65B 35/00; B26D 7/06

(52) U.S. Cl. 209/645; 209/606; 209/659; 83/27

(57) ABSTRACT

In a method, piece goods which differ from one another in at least one property are moved by at least one piece-good conveyor into depositing positions of at least one depositing-position conveyor, in order to form groups which are predefined with regard to this property. The at least one depositing-position conveyor transports these depositing positions parallel but in the opposite direction to the conveying direction of the at least one piece-good conveyor, at least in the region of the transfer of the piece goods into said depositing positions. The picker which is in each case last in the conveying direction of the at least one depositing-position conveyor completes the groups here. This method makes it possible to implement packaging strategies in a flexible and time-optimized manner.

### FIELD OF THE INVENTION

The invention relates to a method and an apparatus for repositioning individually packaged products, in particular to make precise-weight packages, as generically defined by the preamble to claim 1.

### PRIOR ART

In the prior art, perishable individually packaged products, especially foodstuffs, are packed by hand, by means of mechanical apportioning devices, or in so-called robot lines. European Patent Disclosure EP 0 250 470 discloses such robots, also called pickers or delta robots, that are suitable for use in packaging lines. This involves a robot with a base body to which a working part is pivotably connected via three two-part arms, and in turn, grippers or suction elements are disposed on the working part. From U.S. Pat. Nos. 6,543,987 and 6,896,473, further developments are known in which the delta robot has a variable-length fourth axis. Instead of the delta robots, other pick-and-place robots are also suitable, such as the so-called Scara robot or 6-axis robot.

In the case of cookies, chocolate, or other industrially produced articles, it is relatively simple to fill all the packages the same, so that the final products are identical. In natural products, such as meat products, poultry, fish, fruits, or vegetables, this is hardly possible, since the individual individually packaged products are too variable in shape and weight. Precise-weight packaging has advantages in terms of sales: Price marking is simplified, since all the packages can be labeled with the same price. This has a favorable effect on the purchasing behavior of the customer, since he always gets the same quantity. Among other things, the customer will not as often pick up several packages before deciding to buy a particular one of the packages.

One solution to the problem would be to make the products correspondingly smaller, so as to obtain finished packages of identical weight. However, this is not always appreciated by consumers, since this means they can never know whether they are getting whole products, or parts divided into pieces. If the most identical possible size or shape is wanted, then nonconforming individually packaged products could be detected via a camera and rejected. However, this leads to excessive rejection of unused individually packaged products.

International Patent Disclosure WO 2005/106405 therefore discloses a computer-supported method for packaging individually packaged products of different sizes, in which the size of each individually packaged product is first estimated, or the weight is determined; then its location on the conveyor belt is recorded. Next, the particular container in which the individually packaged product is to be deposited is determined.

In International Patent Disclosure WO 01/22043, it is proposed that the individually packaged product be placed in the container using a robot arm, and the robot arm on lifting the individually packaged product determines its weight at the same time.

In U.S. Pat. No. 6,722,506, the individually packaged products are assigned to a plurality of receiving stations, and after the individually packaged products are weighed, they are assigned to a preferred receiving station, and after monitoring of simulated efficiency of the assignment process, changes in the assignment are proposed. U.S. Pat. No. 6,321,135 also attempts to solve the problem, using a relatively complicated algorithm.

In International Patent Disclosure WO 99/28057, the goal is for sausages that are supplied in a random arrangement to be aligned and grouped automatically. To that end, the sausages are already grouped on the delivery belt and fed onward in groups. A control unit assesses the random order status on the delivery belt and determines the randomly defined location of the group on the delivery belt so that the group as a whole can thereafter be deposited in the container in the correct or optimal location.

All these methods have the disadvantage that they either require relatively complicated control and/or are relatively slow and hence inefficient.

Typically, individually packaged product conveyors and container conveyors are operated parallel to one another in cocurrent flow; that is, their conveying directions extend parallel to one another, with the beginning and ending points each on the same side. However, European Patent Disclosure EP 0 865 465 describes a system with a countercurrent principle; that is, the container conveyors do extend parallel to the individually packaged product conveyors, but in the opposite direction to the conveying direction of the individually packaged product conveyor.

European Patent Disclosure 1 285 851 proposes a method for increasing the service life or maximum duration of use of the picker robots that are used along such picker lines on the cocurrent or countercurrent principle. For that purpose, the robots are controlled, on the specification of the arrangement of individually packaged products on the delivery conveyor, in such a way that they are utilized chronologically as uniformly as possible and are not subject to major fluctuations in capacity.

In European Patent Disclosure EP 1 352 831, the relative speed between the delivery of the containers and the delivery of the individually packaged products in the vicinity of the picker line is controlled. The control of the relative speed is effected as a function of a fill status of at least one storage element. This method enables efficient repositioning of individually packaged products in containers with as complete filling as possible.

### SUMMARY OF THE INVENTION

It is an object of the invention to enable a method and an apparatus for repositioning individually packaged products, in particular for weight-controlled packaging, that are as efficient as possible.

This object is attained by a method having the characteristics of claim 1 and an apparatus having the characteristics of claim 22.

In the method of the invention, individually packaged products that differ from one another in at least one property are repositioned by at least one individually packaged product conveyor in deposition positions of at least one deposition position conveyor. The aforementioned property is recorded at some arbitrary time during the method. The method has the following steps:
conveying the individually packaged products on the at least one individually packaged product conveyor along a picker line having at least two pickers disposed in succession in the conveying direction of the individually packaged products;
grasping of the individually packaged products by the pickers and transferring them to one of the deposition positions as a function of the detected property of the individual individually packaged products; and
forming a predefined group, with regard to the aforementioned property, in the deposition position.

The method of the invention is characterized in that the at least one deposition position conveyor transports the deposition positions at least in the region of transferral of the individually packaged products to these deposition positions, in parallel but in the opposite direction to the conveying direction of the at least one individually packaged product conveyor; and that at least one of the last pickers in the conveying direction of the at least one deposition position conveyor completes the groups.

Thanks to the countercurrent principle, the particular picker that still has the task of filling the final empty spaces of the group or in the container has a great selection of individually packaged products available. This makes it simpler to fill the containers in groups. The desired weight, or other criteria to be met, can be attained with great precision. For instance, it is possible to form groups with a maximum deviation from the desired total weight of ±3 wt. % (weight percent). Practically all individually packaged products can be utilized. The rejection rate is relatively low. Most products can already be packed in their first passage through the picker line, so that their dwell time in the picker line is minimized. This not only lowers operating costs but also increases quality assurance for foodstuffs.

No complicated, time- and cost-consuming control programs are necessary. The object can be attained for the individual deposition positions individually, without necessarily requiring the complete overview of the apparatus. In a simple variant of the method, the pickers fill the containers without taking the weight of individual individually packaged products into account. Only the last picker or pickers in the conveying direction of the containers fill the containers such that the desired total weight of the container contents is then attained. In other embodiments, the preceding pickers also take the corresponding weights into account.

According to the invention, the last pickers look for a suitable individually packaged product for a certain container. The first or front pickers in the conveying direction of the containers look for a suitable container for the few individually packaged products still available. Depending on the type of system, the change between these two different filling strategies takes place in the middle of the conveyor route. The middle pickers can change the filling strategy on their own, or on the specification of a central controller, in each case in accordance with the supply of individually packaged products.

The individual strategies for filling the individual containers or groups can be implemented locally for the individual pickers or robots, so that once again, expensive and complex optimization and control of the overall system is dispensed with. As a result, not only are the costs of the system more optimal but the system is also more stable and less vulnerable to malfunction. If one picker fails, the rest of the system can furthermore continue to be operated as before.

In addition, during the packaging, optimization data for the production process of the individually packaged products can be obtained. Especially such prepared foodstuffs as meat, fish or poultry can be cut to size, in sizes that are urgently needed just then in the packaging process. Since they are delivered to the desired place relatively quickly, the waiting time is minimal.

When individually packaged products are packed to make precise-weight finished packages, the metrological requirements specified by government control agencies must also be taken into account. Finished packages with the same rated filling quantity must for instance meet the following requirements:
The average value of the filling quantity of lots or batches that are still to be defined must not be any less than the rated filling quantity.
The filling quantity of the finished package must not exceed a maximum negative deviation, which is dependent on the rated filling quantity.

The requirement that no negative variation is allowed in the batch weight can have the effect that for individual finished packages, the target weight has to be increased so that the batch weight is not undershot. These additional weights often mean costs that the producer himself must bear.

if the batch weight is now included in the repositioning strategy, then further savings can be achieved, since only in this way can the permitted negative variations be fully exploited in the individual packaging. Without observation of the batch weight, a negative variation would not be permitted either for an individual package, since it could not be precluded that an impermissible negative batch would result from a plurality of “negative packages”.

Further advantageous variants of the method will become apparent from the dependent claims.

### BRIEF DESCRIPTION OF THE DRAWINGS

The subject of the invention will be described below in terms of preferred exemplary embodiments, which are shown in the accompanying drawings.

FIG. 1 is a schematic illustration of a packaging line in a first embodiment of the invention;

FIG. 2 is a schematic illustration of a packaging line in a second embodiment of the invention; and

FIG. 3 is flow chart of a possible work sequence of an individual picker; and

FIG. 4 is a schematic illustration of a selection criterion for the individual pickers.

### WAYS OF EMBODYING THE INVENTION

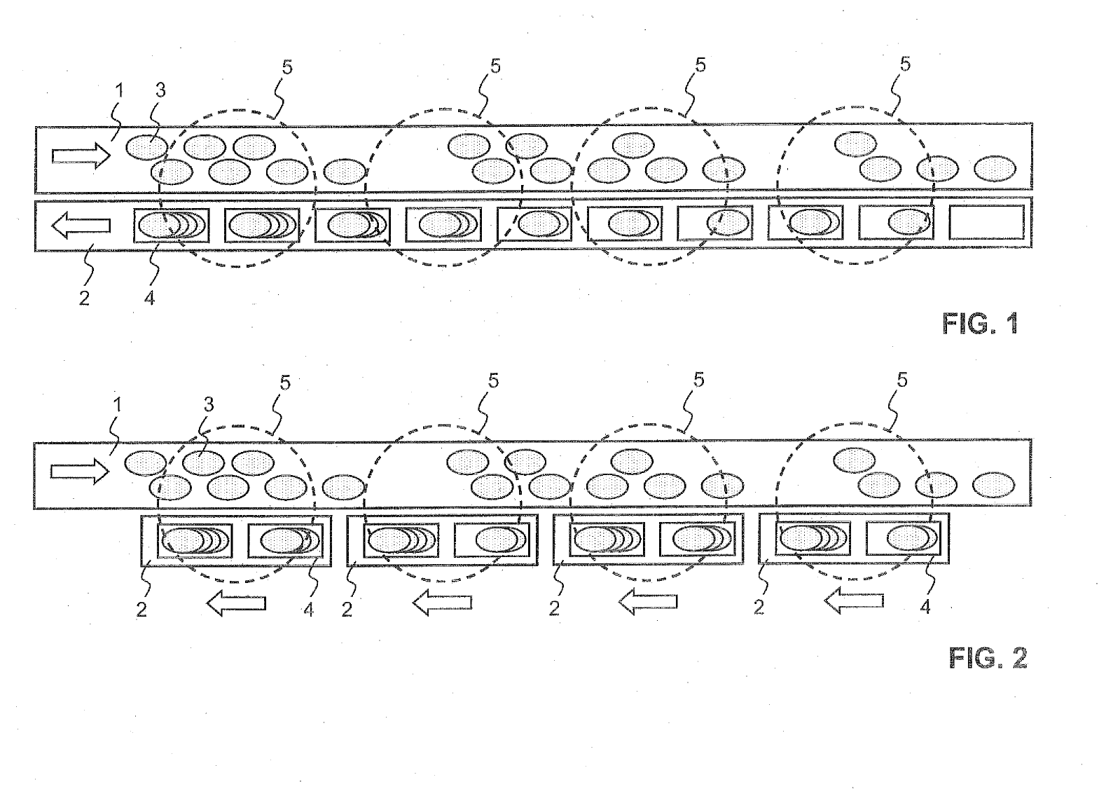

In FIG. 1, a first exemplary embodiment is shown, in terms of which the method of the invention will be explained.

On at least one individually packaged product conveyor 1, individually packaged products are carried along a picker line. Typically, they are transported in random order. The picker line is formed by at least two and preferably more pickers or robots disposed one after another in the conveying direction of the individually packaged product conveyor 1. In the drawings, it is not the pickers themselves but rather their particular operating ranges 5 that are represented by circles. There is also at least one deposition position conveyor 2, which is operated in parallel to the individually packaged product conveyor 1 but in the opposite direction. Conventional containers 4 are carried on the deposition conveyor 2. However, it may also have cavities or other predefined positions for the deposition of the individually packaged products. The individually packaged products can also be simply placed on a conveyor and grouped without previously identified deposition positions. These groups can then be repositioned in order in a container or a cavity. However, they can also simply be filled in a bag or other container together, in random order.

The conveyors 1, 2, however, are typically not necessarily belt or chain conveyors. They can be moved continuously or intermittently or sped up and slowed down on the specification of a controller. The robots are preferably delta robots of the type mentioned at the outset. However, still other automatically controlled robots or pickers can be used. They can have a controller or a control system of a known kind. In particular, they can have a common master controller or can have parts of the controller individually and forward data to a central controller, or they can have controllers of equal rank without a master and thus communicate directly with one another. The robots may have vacuum grippers, clamping grippers, or other suitable means for grasping and repositioning. The pickers may be designed such that they pick up and reposition the individually packaged products individually, pick them up individually and group them and then reposition them in groups, or pick them up in groups and set them down individually.

In the embodiment of FIG. 1, the sole deposition position conveyor 2 extends over the entire length of the picker line parallel to the individually packaged product conveyor 1. In FIG. 2, a plurality of deposition position conveyors 2 are disposed one after the other in the conveying direction along the picker line. Preferably, each picker has its own deposition position conveyor 2.

The goal of the repositioning method in both embodiments is for the individually packaged products furnished on the individually packaged product conveyor 1, which differ from one another in at least one property, to be repositioned by means of the pickers in the containers 4 or at the deposition positions in such a way that they form groups which are predefined with regard to this property.

For instance, they can form groups which have a certain common weight. They can also form groups in which there is one heavy piece along with one or more light pieces each. The containers are preferably all filled up to the same weight. However, they can also have predefined different total weights. It is also possible for all the individually packaged products within one group to have approximately the same weight and for the groups to have different weights from one another.

They can also be grouped with regard to their shape; for instance, two large individually packaged products and two small individually packaged products can form one common group. They can also be arranged with regard to their shape. For instance, straight pieces in the inner region of the group and curved pieces on the outside. Visually attractive pieces, such as pieces of meat with the smallest proportion of fat, can be disposed at the top or bottom in the group, while less-attractive pieces can be disposed inside the group, concealed by the other pieces. The appearance can be a criterion or a property, an example being the color. The type of group formation and the selection of the particular property have virtually no limits, as long as this property of the individually packaged products is detectable and can be processed by the pickers.

When the term “weight” is used both above and hereinafter, especially for poultry, this is merely one preferred variant of the method. The teaching of the invention thus imparted can be implemented with other properties as well.

In the method of the invention, the particular property, such as the weight of the individually packaged products, must now be known. To that end, the weight of the individually packaged products can be detected before their transfer to the individually packaged product conveyor 1, for instance by weighing them. The weight can also be ascertained by optical or mechanical detection of the size and recalculation with the aid of the density. It is also possible to integrate a scales with the individually packaged product conveyor 1 or to dispose a suitable optical or mechanical detection system in or above the conveyor route. The pickers themselves can also be provided with a detection system, such as a weighing arm. The containers themselves and the deposition positions may be exposed to detection means as well. For instance, partly filled containers can be weighed.

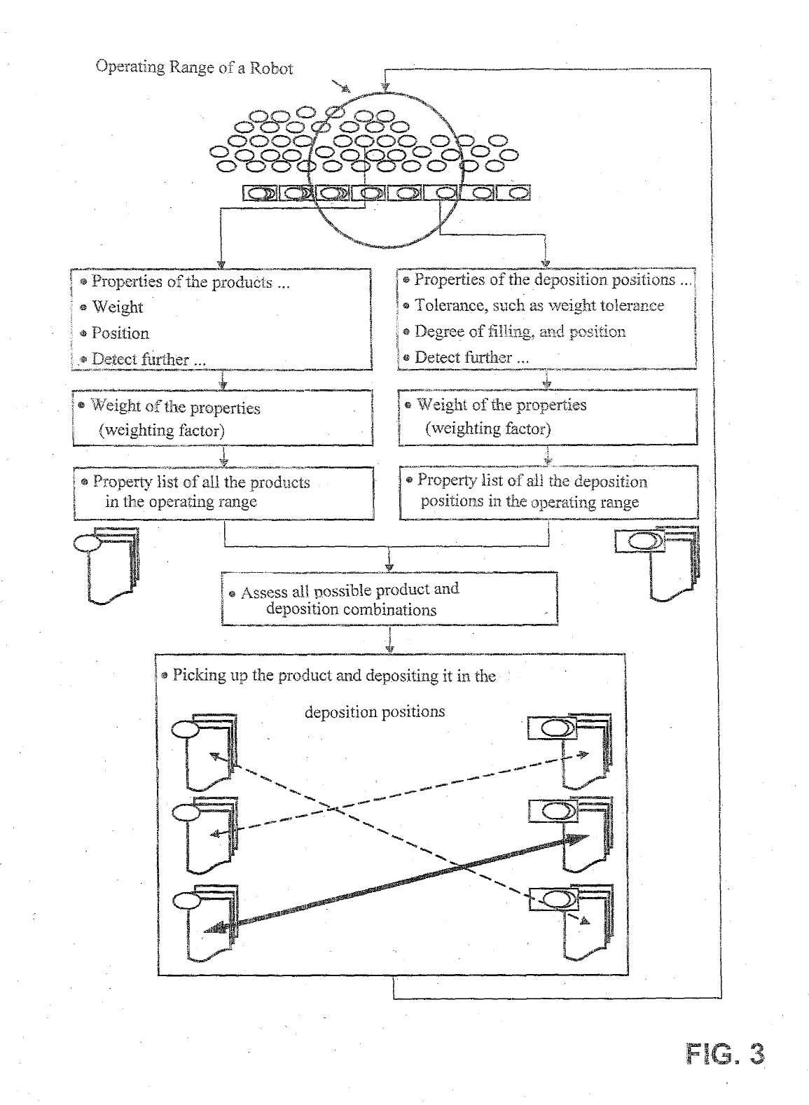

Below, in conjunction with FIG. 3, a variant of the method will be described of the kind that can be used for instance in a system in accordance with FIGS. 1 and 2. The operating range of one of the last robots is represented by a circle. The individually packaged products are in readiness on the individually packaged product conveyor, and the containers have already been partly filled. The containers are conveyed in countercurrent fashion to the individually packaged products. The individually packaged products that are located within the operating range of the robot are detected with regard to their property that is to be taken into account. This property may, as indicated in the list, be the weight, their position, or some other criterion. The detected property is weighted and provided with a weighting factor. This value is detected into a property list of all the individually packaged products and products located within the work operating range. In addition, the properties of the deposition positions, such as the tolerance with regard to the selected property of the individually packaged product, the filling degree, and the position of the container, and optionally other or further properties can be detected or interrogated by the robot. These properties of the deposition positions are also weighted and provided with a weighting factor, which is stored in memory in a property list. Now the robot controller, or a central master controller, performs an assessment of all the possible combinations of product and deposition. Those product-deposition combinations with the highest assessment are now taken into account, and the robot deposits the appropriate individually packaged product in the corresponding container. The robot can control itself and can also detect the information itself. Preferably, however, it furnishes and receives information from the other pickers and/or from a central controller.

In its repositioning strategy, the picker can take property tolerance lists into account in order to approach as closely as possible to the target weight. If no suitable individually packaged product is present, then it waits until an appropriate one reaches the operating range. During that time, or if no such individually packaged product is furnished for a long time, the container is conveyed onward.

This picking strategy is carried out by at least one last picker in the conveying direction of the container conveyor. This picker or pickers still have a relatively great selection of individually packaged products, since after all they are located at the beginning of the picker line. In the embodiment of FIG. 2, this means the last picker or pickers of the corresponding container conveyor. Depending on the dimensions of the system, only the last picker carries out this strategy. If the picker line is relatively long, with up to 10 robots, for instance, then the last two or three pickers can also be used for this purpose. The picker line can furthermore be dimensioned such that the last picker, or some of the last pickers, are practically always in readiness or in other words are on standby, so that only in exceptional cases do they package the last products, and pickers located farther forward function as the aforementioned last pickers which pursue the aforementioned strategy. This is the case not only for long lines but also in cases in which so many products are furnished that the robots are not sufficiently utilized, so that the preceding robots can already fill the containers.

Conversely, with the front or first pickers in the conveying direction of the containers, the individually packaged product is at the middle point. In other words, these pickers look for a container that fits the few individually packaged products still available on the individually packaged product conveyor. For instance, they can place heavy products in containers that are located far apart, so that later there will not be a need in rapid succession for an especially lightweight individually packaged product.

The change in filling strategy takes place at an arbitrary point along the picker line, preferably in the middle or in the rear region of the container conveyor.

Preferably, this change is not performed at some rigid place but instead is made as a function of what the current supply of empty spaces in the containers is and what the number of individually packaged products available looks like. This means that the middle pickers change from a filling strategy in which the containers are the focus of attention, to a filling strategy in which the individually packaged products are given more consideration.

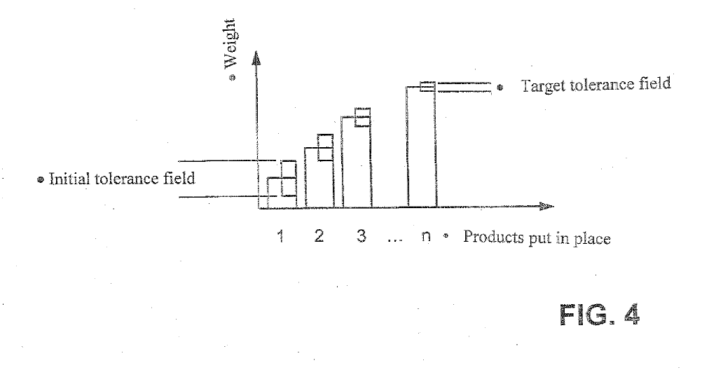

In FIG. 4, it is shown how the individual pickers along a picker line can operate with different or varying tolerance fields. The size of the tolerance fields depends on how many products have already been placed in the container. The allowed tolerance decreases with each product put into the container. As a consequence, the first picker in the conveying direction of the container conveyor can still have a wide tolerance range; that is, it can also select individually packaged products that in terms of the selected property are far from the target value. This tolerance field shrinks increasingly in the conveying direction of the container conveyor and is typically less for each subsequent picker than for its predecessor. Usually the at least one last picker has the smallest field; this picker must select the individually packaged products in such a way that if at possible all the containers reach the desired target size.

Still other possible repositioning strategies are possible, all based on the fact that the last picker, since it has the greatest selection, will fill the containers completely whenever possible. For instance, it is also possible to form the best pairs, so that the containers can be filled as precisely as possible with the target weight. Weight assessment parameters are taken into account in that case, and the individual pairs are assessed on a scale. This strategy as well is executed by at least the last picker or the above-described pickers.

In all the variants, however, even preceding pickers or all the pickers can also have repositioning strategies. For instance, the first picker in the conveying direction of the container can first reposition the individually packaged products that are more out of the ordinary, such as the very heavy pieces or very light pieces. It is then simpler to find fitting individually packaged products later than if those exceptional pieces had to fit into already partly filled containers.

It is also possible early, or by means of the last picker in each case, to take into account whether the target for a specific container can even be attained at all. The repositioning strategies can be selected such that the assumption is optimal average values, so that as many containers as possible reach the desired goal. The individual robots can be provided with tolerance criteria, so that they reposition only individually packaged products that are located within these tolerance limits. These tolerance limits can decrease more and more along the conveying direction of the containers, or in other words, at the beginning, for instance, individually packaged products with a weight of plus/minus 10% of an ideal weight can still be repositioned, while with subsequent pickers only those with a weight of plus/minus 5%, and toward the end of the line only plus/minus 3%, are repositioned.

If the batch weight is taken into account in the repositioning strategy, then it can for instance be monitored whether in a weight analysis over an arbitrary period time the average value of the individual packages produced, or containers filled with individually packaged products, is not below the rated weight. To that end, an arbitrary time interval can be specified (such as 30 minutes). The sliding average value is shown over this time interval.

For instance, the calculation of the sliding average value is done by the following plan:
average value calculation [0, 30] after 30 minutes;
average value calculation [1, 31] after 31 minutes;
average value calculation [2, 32] after 32 minutes;
. . .
average value calculation [x−30, x] after x minutes.

In the delivery of the individually packaged products to the individually packaged product conveyor or during the transporting of the individually packaged products thereon, it is also possible to work toward the attainment of this goal by processing individual individually packaged products, for instance cutting them to size. A generally preceding production process of the individually packaged products can also be varied accordingly. Individual individually packaged products can also be placed in buffer stores, for instance if too large a number of individually packaged products that are outside a norm are supplied. Any individually packaged products no longer repositioned at the end of the picker line can be classified with regard to their property before being return to the repositioning process and on being returned can be delivered purposefully to a particular picker that just at that time requires individually packaged products of that classification. This optimizes their further dwell time in the picker line.

In groups in which the predefined property cannot be attained, at least some of the individually packaged products can be removed from the group and put back on the individually packaged product conveyor.

As a peripheral condition, the maximum or minimum number of individually packaged products per container can also be specified. The number of products per container or package can vary within arbitrarily definable limits [1 . . . n]; that is, in this way packages with a precise weight containing a variable number of products are attained. By the last robot, the target rate must have been reached. Naturally, this adjustment cannot wait to be accomplished until the last robot, but must happen at each robot, as a function of the situation.

The desired weight must be within the allowable tolerance; inseparable combinations must be rejected early on. The goal is products of as uniformly heavy a weight as possible in the container.

The desired weight of the filled container, tolerance fields for the first and last product, and the minimum and maximum number of products per finished package are predetermined.

Tolerance field matrices, which as a function of the possible number and the instantaneous number of individually packaged products in the container make “permitted” tolerance fields available for selection are calculated.

For that purpose, the following algorithm can be employed:
Calculation of the average weights per product as a function of the number of products [1 . . . n] per container; for instance, desired weight 500 g; 4 pieces >o /-125.0 g, 5 pieces>o /-100.0 g, 6 pieces>o /-83.3 g
Calculation of the tolerances in grams; for instance, desired weight 500 g; lower tolerance ±5.00% >±25.00 g, upper tolerance ±1.25% >±6.25 g
Linear calculation of the tolerances between [1 . . . n]; for instance, tolerance 25.00-6.25 g: 4 pieces >25.00-18.75-12.50-6.25 g
Toleration of the average weights with the tolerances, such as 4 pieces:
1: 100.00-125.00-150.00 g
2: 131.25-250.00-268.75 g
3: 362.50-375.00-387.50 g
4: 493.75-500.00-506.25 g

The result is a field with discrete permitted weight ranges which may possibly overlap. In the filling process, the container weight changes incrementally upward continuously through these weight ranges.

Various deposition patterns for depositing the individually packaged products at the deposition positions can be taken into account so that the individually packaged products are deposited in optimized fashion with regard to their aforementioned property and with regard to their deposition position.

The method according to the invention thus enables flexible, time-optimized implementation of packaging strategies.

1-22. (canceled)

23. A method for repositioning individual products which differ in at least one property from one another, from at least one individual product conveyor into deposition positions of at least one deposition position conveyor, in which the aforementioned property is recorded at any arbitrary time in the method, and the method has the following steps:
conveying the individual products on the at least one individual product conveyor along a picker line having at least two pickers disposed in succession in a conveying direction of the individual products;
grasping of the individual products by the pickers and transferring them to one of the deposition positions as a function of a detected property of the individual products;
forming a predefined group, with regard to the detected property, in the deposition position;
wherein the at least one deposition position conveyor transports the deposition positions at least in a region of transferral of the individual products to these deposition positions, in parallel but in an opposite direction to the conveying direction of the at least one individual product conveyor, and
at least one last one of the pickers in the conveying direction of the at least one deposition position conveyor completes the step of forming the predefined group.

24. The method as defined by claim 23, wherein the aforementioned property is weight, and the groups have a predetermined weight.

25. The method as defined by claim 23, wherein each group has a same predetermined weight.

26. The method as defined by claim 23, wherein the individual products within one group have approximately a same weight, and each group has a different weights from one another.

27. The method as defined by claim 24, wherein weight is determined by weighing or by optical detection of a size.

28. The method as defined by claim 23, wherein the property is at least one of the following characteristics: a shape of the individual products, a size of the individual products, a coloring of the individual products, and an appearance of the individual products, for the sake of suitable disposition of the individual products within the deposition position.

29. The method as defined by claim 23, wherein the individual products are repositioned into deposition positions in a form of cavities or containers.

30. The method as defined by claim 23, wherein the aforementioned property of the individual products is determined at least one time in the following group: even before the individual products are conveyed on the individual product conveyor; during the conveying of the individual products on the individual product conveyor; and upon repositioning of the individual product by means of the picker in the deposition position.

31. The method as defined by claim 23, wherein at least an uppermost picker in the conveying direction of the at least one deposition position conveyor repositions the individual products without taking the aforementioned property into account.

32. The method as defined by claim 31. wherein only the at least one last picker repositions the individual products taking into account a group located in a deposition position and still to be completed by that picker and taking into account the aforementioned property of the individual products delivered on the individual product conveyor.

33. The method as defined by claim 23, wherein upon a repositioning of all the individual products, the aforementioned property and attainability of the predefined group are taken into account.

34. The method as defined by claim 23, wherein individual products are processed before or during their transport on the individual product conveyor, taking into account the individual products already deposited in deposition positions.

35. The method as defined by claim 34, wherein the individual products are cut before or during their transport on the individual product conveyor.

36. The method as defined by claim 23, wherein individual products are deposited in a buffer store.

37. The method as defined by claim 23, wherein at an end of the picker line, individual products that can no longer be repositioned are classified with regard to their property before their return to repositioning, and upon their return are intentionally delivered to a picker that requires individual products of that classification just at that time.

38. The method as defined by claim 23, wherein groups in which the predefined property cannot be attained, at least some of the individual products are withdrawn again and put back on the individual product conveyor.

39. The method as defined by claim 23, wherein a number of individual products per group is predefined.

40. The method as defined by claim 23, wherein it takes various deposition patterns for depositing the individual products in the deposition positions into account in order to deposit the individual products optimally with regard to their aforementioned property and to their deposition position.

41. The method as defined by claim 23, wherein a plurality of individual products are jointly picked up from the individual product conveyor by a same picker and deposited individually or jointly in the deposition positions.

42. The method as defined by claim 24, wherein a sliding average of the weights of produced groups within batches of groups is determined at an arbitrary time interval and taken into account in repositioning of the individual products.

43. The method as defined by claim 42, wherein the groups are produced such that an average value of weights of produced groups is not below a predetermined rated value.

44. An apparatus for performing the method as defined by claim 23, having a picker line including at least two pickers, at least one individual product conveyor which extends along the picker line, and at least one deposition position conveyor which extends along the picker line, wherein at least in a region of the picker line, the at least one deposition position conveyor extends parallel to the individual product conveyor but is operated in a opposite direction from it.
